(19) United States
(12) Patent Application Publication
(10) Pub. No.: US 2025/0095910 A1
(43) Pub. Date: Mar. 20, 2025

(54) INDUCTOR

(71) Applicant: Coilcraft Inc., Cary, IL (US)

(72) Inventors: Scott Hess, Crystal Lake, IL (US); David Cherek, Marengo, IL (US); Andrew Klesyk, Crystal Lake, IL (US); Hyeonchul Park, Mount Prospect, IL (US); Tae Kwang Kim, Vernon Hills, IL (US)

(21) Appl. No.: 18/824,207

(22) Filed: Sep. 4, 2024

Related U.S. Application Data
(60) Provisional application No. 63/544,514, filed on Oct. 17, 2023.
(60) Provisional application No. 63/538,700, filed on Sep. 15, 2023.

(51) Int. Cl. H01F 27/32; H01F 27/29; H01F 27/30; H01F 41/12

(52) U.S. Cl. CPC H01F 27/327; H01F 27/292; H01F 27/306; H01F 41/127

(57) ABSTRACT

An exemplary inductor includes: a core; at least one winding at least partially arranged around the core, wherein each of the at least one winding includes a vertically-oriented “U” shape; and an overmold covering an upper region of the core and at least a portion of each of the at least one winding.

### CROSS REFERENCE TO RELATED APPLICATIONS

This application claims the benefit of U.S. Nos. 63/538,700 and 63/544,514, filed on Sep. 15, 2023 and Oct. 17, 2023, respectively, the entireties of which are incorporated by reference herein.

### BACKGROUND

Generally, this application relates to inductors, such as “bead” inductors used in electronics.

### SUMMARY

According to embodiments, an inductor includes: a core; at least one winding at least partially arranged around the core, wherein each of the at least one winding includes a vertically-oriented “U” shape; and an overmold covering an upper region of the core and at least a portion of each of the at least one winding. Each of the at least one winding may include two terminals on an underside of the inductor, wherein the terminals are butt joint terminals. The at least one winding may be a plurality of windings. The overmold may not cover portions of the at least one winding, including terminals of each of the at least one winding. The uncovered portions of the at least one winding each extend at least 0.1 mm below a lower surface of the core.

According to embodiments, an inductor includes: a core; at least one winding at least partially arranged around core, wherein each of the at least one winding has a horizontally-oriented “U” shape portion and two vertically-oriented portions extending downwardly from corresponding ends of the horizontally-oriented “U” shape to a bottom surface of the inductor; and an overmold covering the core and at least a portion of each of the at least one winding. Each of the at least one winding may include two terminals on a bottom surface of the inductor on respective ones of the two vertically-oriented portions of the winding, wherein the terminals may be butt joint terminals. The inductor may further comprises a dummy winding not electrically connected to the at least one winding, wherein the dummy winding includes at least one dummy winding terminal on a bottom surface of the inductor, wherein the overmold may cover at least a portion of the dummy winding and wherein the at least one dummy winding terminal may include a butt joint terminal. At least a portion of the dummy winding including the at least one dummy winding terminal may extend at least 0.1 mm below a lower surface of the core. The at least one winding may include a plurality of windings. The overmold may not cover a portion of the at least one winding, including the two terminals of each of the at least one winding. Uncovered portions of the at least one winding may each extend at least 0.1 mm below a lower surface of the core.

According to embodiments, a method for manufacturing an inductor includes: placing at least one winding on a core; and forming an overmold around the core and at least a portion of the winding by baking a composite material. The method may further include positioning a dummy winding before said forming an overmold, wherein the dummy winding includes at least one dummy winding terminal, and wherein the overmold is formed around at least a portion of the dummy winding. The at least one dummy winding terminal may include a butt-joint terminal. The at least one dummy winding terminal may extend at least 0.1 mm below a lower surface of the core. The overmold may be formed by baking at a temperature between 300-500 degrees F. The overmold may include a binder and a magnetic material, wherein the binder comprises at least one of a thermoplastic, a thermoset, or an epoxy material, and wherein a ratio of the magnetic material to binder by percentage of weight is between 85:15 and 97:3. The winding may include two butt-joint terminals on a bottom surface of the inductor after the overmold has been formed. Uncovered portions of the at least one winding may each extend at least 0.1 mm below a lower surface of the core.

### BRIEF DESCRIPTION OF SEVERAL VIEWS OF THE DRAWINGS

FIG. 1A illustrates a top perspective view of an inductor, according to embodiments.

FIG. 1B illustrates a bottom perspective view of the inductor of FIG. 1A, according to embodiments.

FIG. 1C illustrates an exploded view of the inductor of FIG. 1A, according to embodiments.

FIG. 1D illustrates a bottom plan view of the inductor of FIG. 1A, according to embodiments.

FIG. 2A illustrates a front, top perspective view of an inductor, according to embodiments.

FIG. 2B illustrates a rear, top perspective view of the inductor of FIG. 2A, according to embodiments.

FIG. 2C illustrates a bottom perspective view of the inductor of FIG. 2A, according to embodiments.

FIG. 2D illustrates an exploded view of the inductor of FIG. 2A, according to embodiments.

FIG. 2E illustrates a bottom plan view of the inductor of FIG. 2A, according to embodiments.

FIG. 3A illustrates a top perspective view of an inductor, according to embodiments.

FIG. 3B illustrates a bottom perspective view of the inductor of FIG. 3A, according to embodiments.

FIG. 3C illustrates an exploded view of the inductor of FIG. 3A, according to embodiments.

FIG. 3D illustrates a bottom plan view of the inductor of FIG. 3A, according to embodiments.

FIG. 4A illustrates a top perspective view of an inductor, according to embodiments.

FIG. 4B illustrates a bottom perspective view of the inductor of FIG. 4A, according to embodiments.

FIG. 4C illustrates an exploded view of the inductor of FIG. 4A, according to embodiments.

FIG. 4D illustrates a bottom plan view of the inductor of FIG. 4A, according to embodiments.

FIG. 5A illustrates a top perspective view of an inductor, according to embodiments.

FIG. 5B illustrates a bottom perspective view of the inductor of FIG. 5A, according to embodiments.

FIG. 5C illustrates an exploded view of the inductor of FIG. 5A, according to embodiments.

FIG. 5D illustrates a bottom plan view of the inductor of FIG. 5A, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

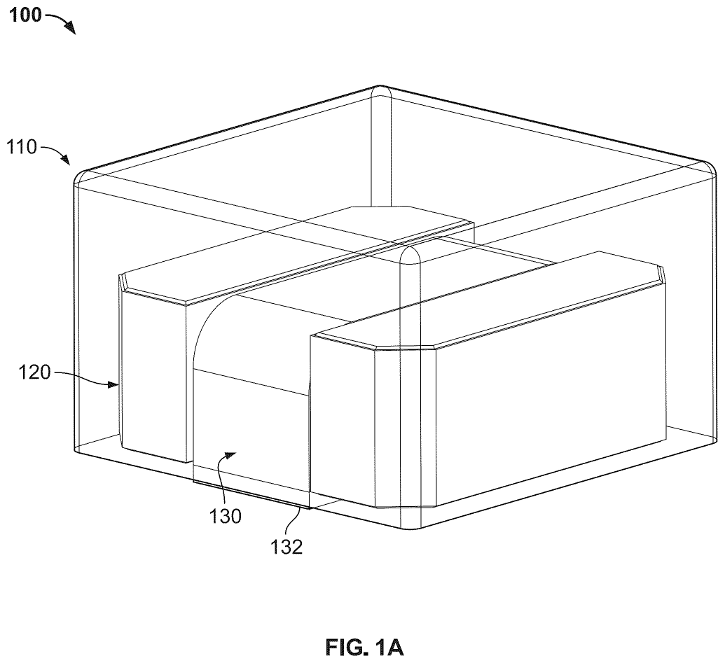

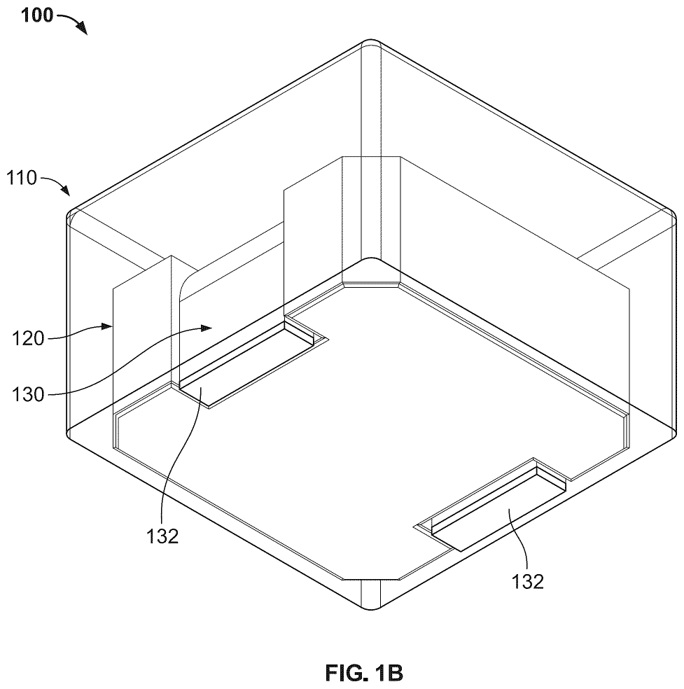

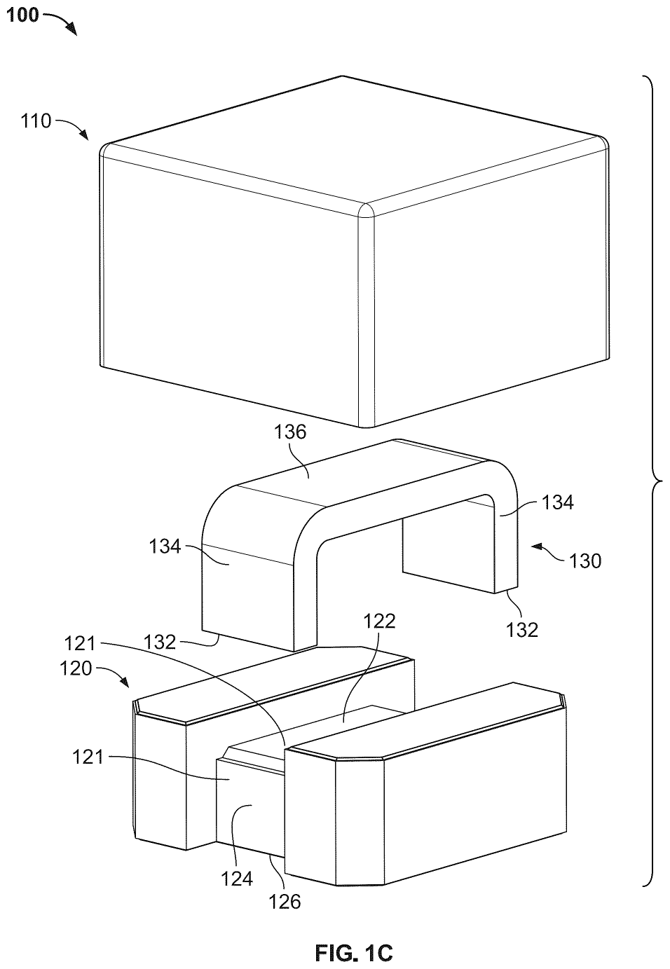

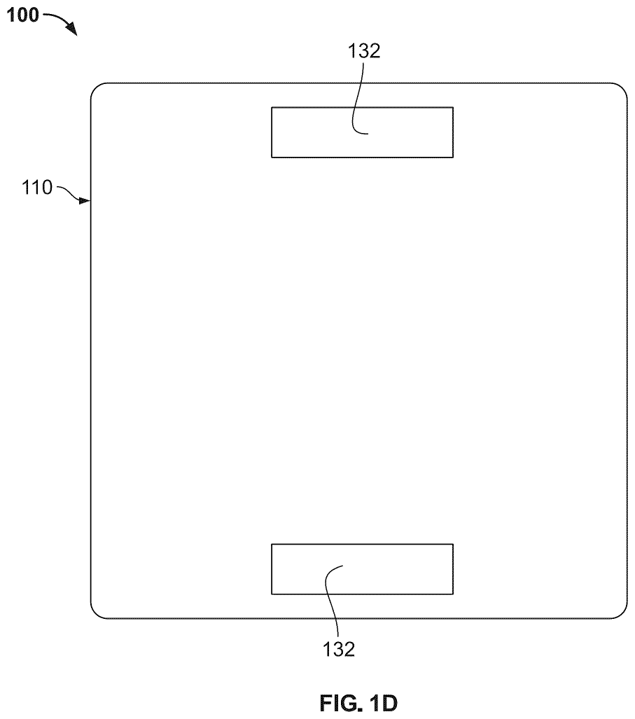

FIGS. 1A, 1B, 1C, and 1D illustrate a top perspective view, a bottom perspective view, an exploded view, and a bottom plan view (respectively) of inductor 100, according to embodiments. The inductor 100 may have an inductance between 10 nH-1.0 μH (e.g. approximately 100 nH). The inductance of the inductor 100 may have a tolerance of +/−5% to +/−30% (e.g., approximately 20%). The inductor 100 may have a DC resistance (DCR) between 0.05-100Ω (e.g., approximately 0.10 mΩ).

Inductor 100 includes overmold 110, winding 130, and core 120. The core 120 may be formed from different materials, such as ferrite or composite. Examples of such materials include: carbonyl iron alloys, silicon iron chromium alloys, silicon iron aluminum alloys, nanocrystalline and amorphous materials, or other soft magnetic materials. Different shapes are possible. Cores may be formed by pressing the material to a shape and then grinding the shape to a final, desired shape. The core 120 may have a length of between 2-30 mm. The core 120 may have a width of between 2-30 mm. The core 120 may have a height of between 1-20 mm.

The core 120 is shown as having a recess 121 or receiving feature to receive the winding 130. The recess 121 may include an upper recess segment 124 extending across an upper surface of the core 120. The recess 121 may further include one or more lateral recess segments 122. The recess 121 may have a width between 0.5-20 mm along its length. The width of the recess 121 may be greater than the corresponding width of the winding 130, as shown. The recess 121 may receive all or a portion of the winding 130. For example, the depth of the recess 121 may be at least as deep or deeper than the thickness of the winding 130. The depth of the recess 121 may be between 0.1-15 mm. As shown, the recess 121 is deeper than the winding 130. The core 120 has a lower surface 126. The lower surface 126 may be substantially planar. The lateral recess segments 122 may extend to the lower surface 126, such as the outer edge of the lower surface 126.

The winding 130 may have a vertically oriented staple shape or “U”-shape, although other shapes are possible. The winding 130 is shown as having an upper segment 136 and two lateral segments 134 on opposing sides of the upper segment 136. The winding 130 is received by the recess 121 in the core 120. The size of the winding 130 may impact the inductance and resistivity (DCR) of the inductor 100. The greater the cross-section of the winding 130, the lower the inductance and DCR may be. Winding may include a material, such as copper, silver, or aluminum

At the ends of the winding 130, there are terminals 132. The terminals 132 may be on the actual ends of the winding 130. The terminals 132 may be substantially planar, and may be formed by, e.g., mold tooling. The terminals 132 may be so-called butt joint terminals. Butt joint terminals can be distinguished from terminals with a clip termination, or terminals with a self-lead under inductor termination terminals. As butt joint terminals, the terminals 132 may be mechanically realized in construction of electronics, because the overmold 110 secures the winding 130 with core 120. Further, as butt joint terminals, the terminals 132 reduce the height of inductor by eliminating bent wire(s) under the inductor 100. Further, as butt joint terminals, the terminals 132 may be “self-leaded” such that no interconnects between the winding 130 and a corresponding terminal 132 are required inside of the inductor 100. Because no such interconnection is needed, there is no risk of failure of such interconnection (e.g., becoming open). Further, circuit manufacturing may be improved because soldering to a butt joint terminal allows for a lower profile part.

The terminals 132 may be substantially flush with a lower surface of the overmold 110, or the terminals 132 may extend below the lower surface of the overmold 110. For example, the terminals 132 may extend between 0.1-1.0 mm below the lower surface of the overmold 110. Further, the terminals 132 may be substantially flush with a lower surface 126 of the core 120, or the terminals 132 may extend below the lower surface 126. For example, the terminals may extend between 0-5 mm below the lower surface 126 of the core 120.

The overmold 110 may be a material with either composite or ferrite magnetic material or a mix thereof. The overmold 110 may be a mix of magnetic powder (ferrite or magnetic composite powder) with a binder. The powder granules for the magnetic powder may have an average or specific diameter between 1-100 μm or up to 900 μm. The powder granules for the binder may have an average or specific diameter between 1-100 or up to 900 μm. The binder may melt during the molding process and later be processed, resulting in a substantially solid overmold. The ratio of magnetic material to binder may be between 85%: 15% to 98%: 2% by weight. The binder may be thermoplastic, thermoset, epoxy or other material that suitably melts and then can be cured or baked to form a molded body. The binder may be a mix of suitable materials. The overmold 110 may be formed by injection, compression, transfer molded, or a combination thereof.

Formation of the overmold 110 may be different than formation of the core 120. For example, the core 120 may be formed by firing at relatively high temperature (e.g., over 800° C.). Such high temperature may increase magnetic properties of the core 120. In contrast, overmold material may be baked at relatively lower temperatures (e.g., 300°−500° F.) to form the overmold 110.

The inductor 100 may be constructed as follows. The winding 130 may be placed on the core 120. The windings 130 may further fit into the part of the mold tooling (e.g., received in recesses of the tool) before forming the overmold in the tool. In this way, the terminals 132 of the winding 130 may not be covered by the overmold 110 and may extend below the lower surface of the overmold 110.

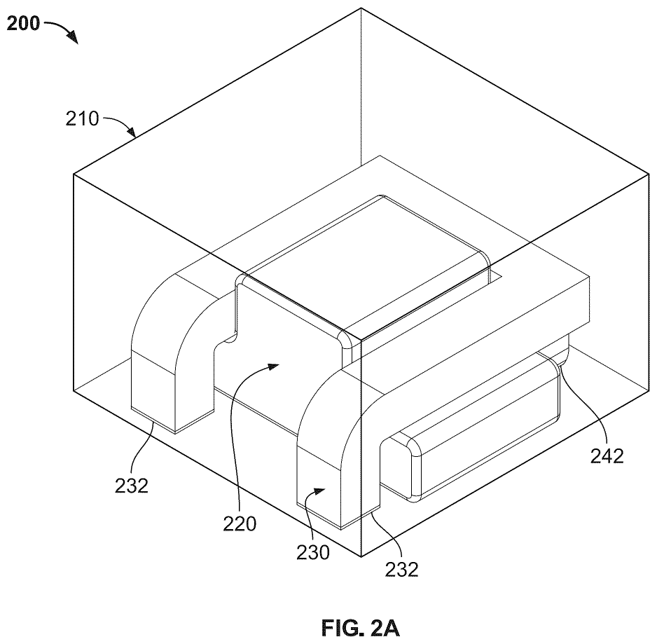

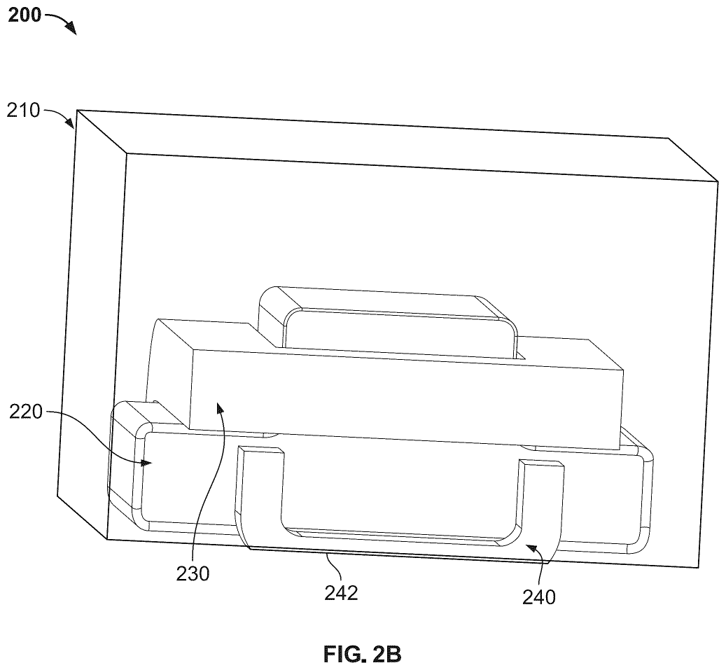

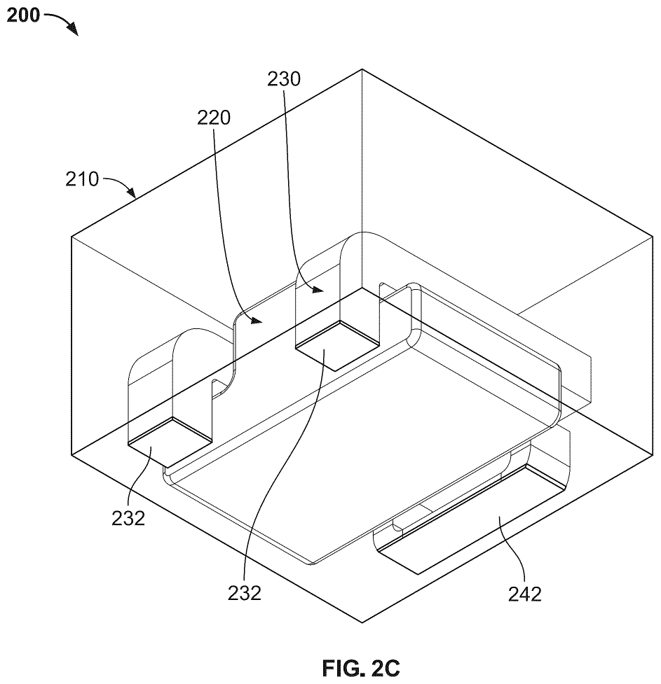

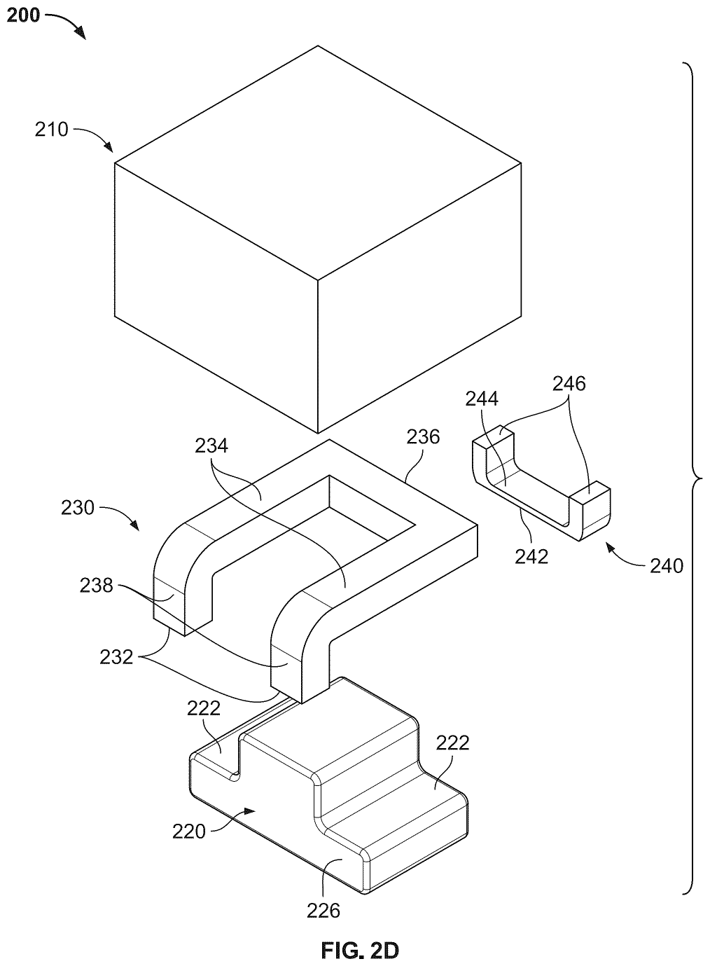

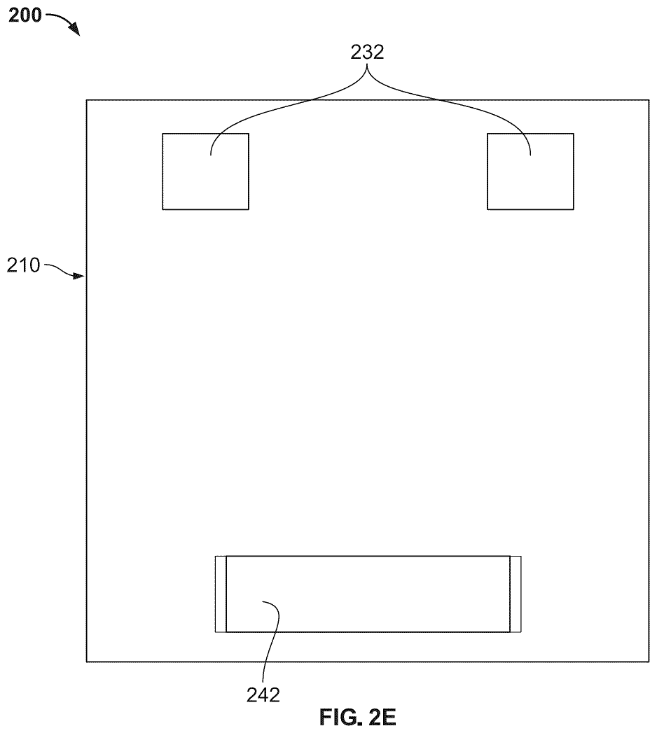

FIGS. 2A, 2B, 2C, 2D, and 2E illustrate a front top perspective view, a rear top perspective view, a front bottom perspective view, an exploded view, and a bottom plan view (respectively) of inductor 200, according to embodiments. The inductor 200 may include a core 220, a winding 230, an overmold 210, and optionally a dummy winding 240. Aspects of the inductor 200 may be similar to those of the inductor 100, as will be understood. For example, the inductance, tolerance, and DC resistance of the inductor 200 may be similar to that of the inductor 100, and therefore will not be repeated here. As another example, the composition and formation of the core 220 may be similar to that of the core 120, and therefore will not be repeated here. Similarly, the composition and formation of the overmold 210 may be similar to that of the overmold 110, and therefore will not be repeated here. Furthermore, the composition and formation of the winding 230 may be similar to that of the winding 130. However, there are differences between the embodiments of inductor 100 and the embodiments of the inductor 200, as will be described.

For the inductor 200, the winding 230 is depicted as having a horizontally oriented “U”-shape 234, 236 in the upper region, with lateral segments 238 extending downwardly from the ends of the “U”. The horizontally oriented “U” shape includes upper widthwise segments 234 parallel with each other, and an upper lengthwise segment 236 connecting the upper widthwise segments 234. The upper lengthwise segment 236 may be substantially perpendicular to the upper widthwise segments 234. The lateral segments 238 are shown as extending downwardly from ends of the upper widthwise segments 234 on an end opposite from that connected to the upper lengthwise segment 236. Other shapes, sizes, or proportions for the winding 230 are contemplated, such as oval, racetrack, or round.

The core 220 is shown as having generally a “T” shape. The core 220 includes recesses 222. The recesses 222 receive at least a portion winding 230. As shown, the recesses 222 receive portions of the upper widthwise segments 234. The upper lengthwise segment 236 is shown as not being received by the recesses 222 or the core 220 more generally. Instead, as shown, the upper lengthwise segment 236 extends along a lateral side of the core 220. Further, the lateral segments 238 are also shown as not being received by the recesses 222 or the core 220 more generally. Instead, as shown, the lateral segments 238 are shown as extending along a lateral side of the core 220 (the lateral side opposite the one in which the upper lengthwise segment 236 extends across).

The dummy winding 240 is shown only in inductor 200, but may be included in inductors 100 or 300. The dummy winding 240, at least partially, facilitates stable mechanical connection of the inductor 200 to a substrate (e.g., circuit board). In the example of inductor 200, the terminals 232 of the winding 230 are on one side of the inductor 200. Therefore, if the inductor 200 is coupled to the substrate via the terminals 232, the inductor 200 is only coupled on one side. The dummy winding 240 allows for a connection between the inductor 200 and substrate on an additional side of the inductor, thereby improving stability of the assembly. More than one dummy winding 240 may be included in the inductor 200 to provide additional points of contact to improve mechanical coupling and stability of the inductor 200 to the substrate. Again, dummy winding(s) may be included in inductors 100 or 300.

The dummy winding 240 includes at least one terminal 242 (e.g., only one terminal) on a bottom surface of the inductor 200. The dummy winding terminal(s) 242 may be butt joint terminal(s). In the illustrated example, the dummy winding terminal 242 is an elongated terminal. The dummy winding terminal(s) 242 may be substantially flush with a lower surface of the overmold 210 and/or a lower surface 226 of the core 220. Or the dummy winding terminal(s) 242 may extend below the lower surface of overmold 210, and/or below the lower surface 226 of the core 220. For example, the dummy winding terminal(s) 242 may extend between approximately 0.1-1.0 mm (e.g., approximately 0.5 mm) below the lower surface of overmold.

The dummy winding terminal 242 may be on a lower surface of the dummy winding 240. For example, the dummy winding 240 (as shown) includes a horizontal segment 244 and two vertical segments 246 extending from opposite ends of the horizontal segment 244. The terminal 242 is exemplarily shown as on the lower surface of the horizontal segment 244. The vertical segments 246 may extend upwardly into the overmold 210 to stabilize the dummy winding 240 within the inductor 200.

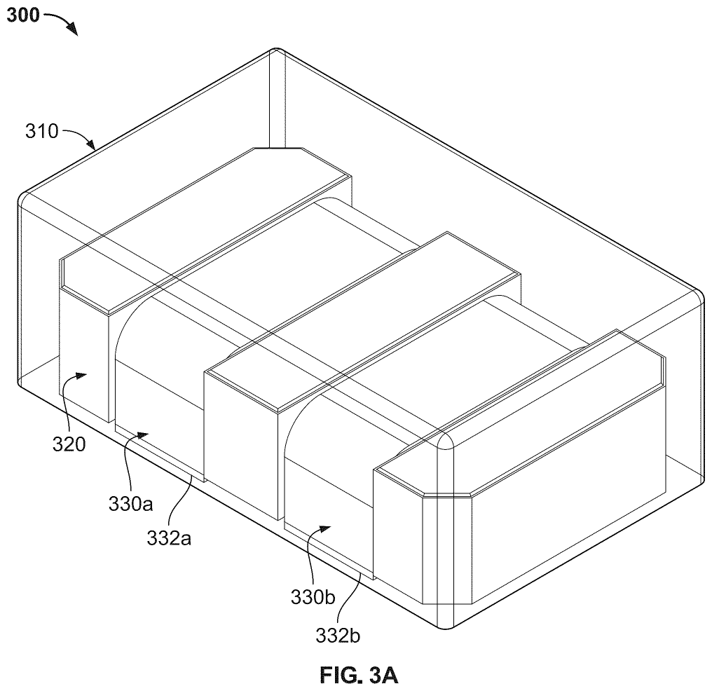

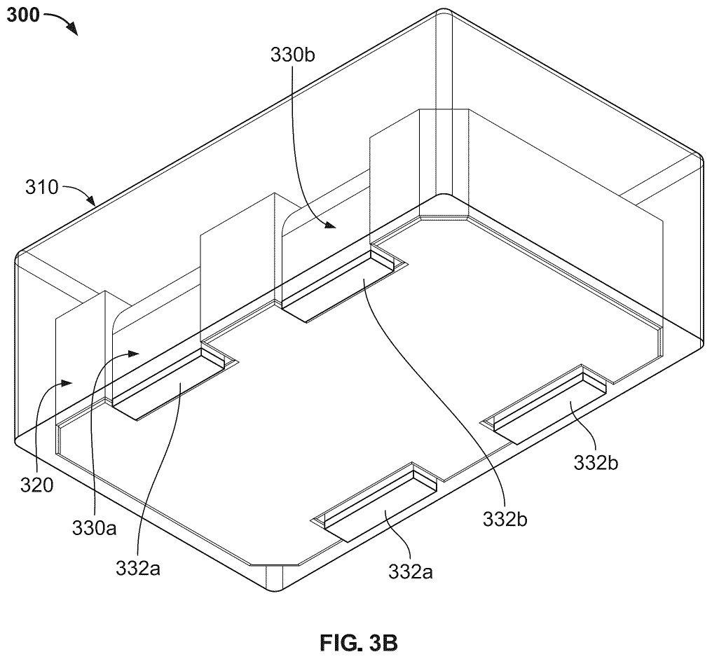

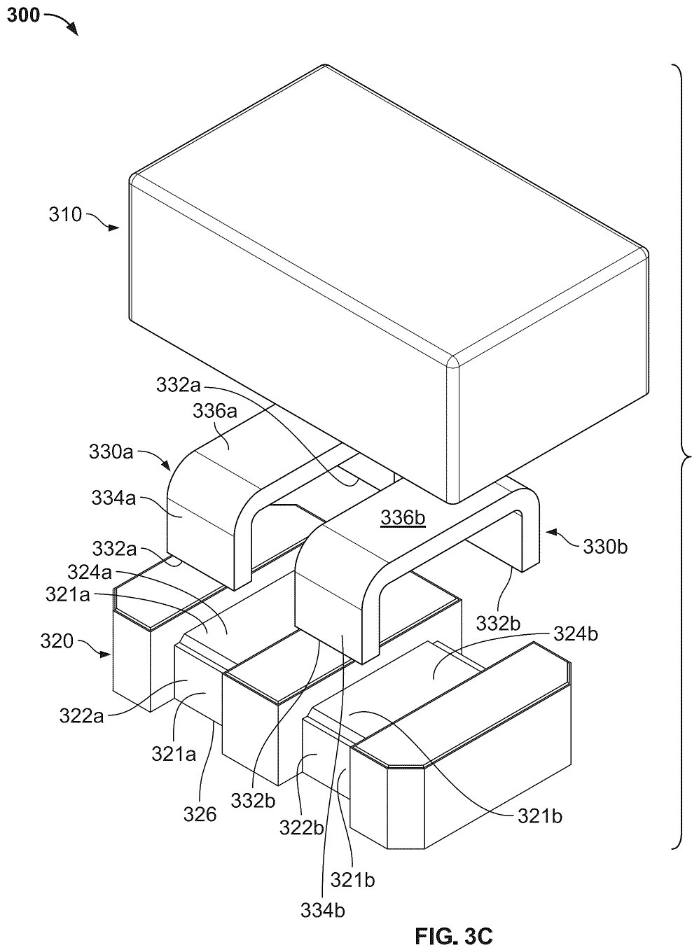

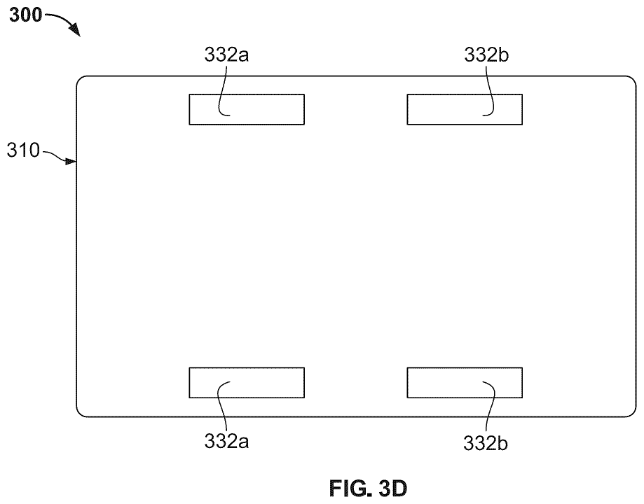

FIGS. 3A, 3B, 3C, and 3D illustrate a top perspective view, a bottom perspective view, an exploded view, and a bottom plan view (respectively) of an inductor 300, according to embodiments. The inductor 300 may be similar to the inductor 100, except that the inductor 300 includes multiple windings 330a, 330b and corresponding features in the core 320. Therefore, the specific descriptions will not be repeated here. The inductor 300 is shown as having two windings 330a, 330b, but three or more windings (and corresponding features on the core 220) are also contemplated. The windings 330a, 330b may be identical to each other. The corresponding features on the core 220 that receive the windings 330a, 330b may also be identical to each other. As exemplarily depicted, the first winding 330a includes two terminals 332a at the ends of respective lateral segments 334a. The lateral segments 334a are connected to each other by an upper segment 336a. The core 320 receives the first winding 330a, with a recess 321a including two lateral segments 322a connected by an upper recess segment 324a. As exemplarily depicted, the second winding 330b includes two terminals 332b at the ends of respective lateral segments 334b. The lateral segments 334b are connected to each other by an upper segment 336b. The core 320 receives the first winding 330b, with a recess 321b including two lateral segments 322b connected by an upper recess segment 324b. The inductor 300 may be constructed in a similar manner as the inductor 100.

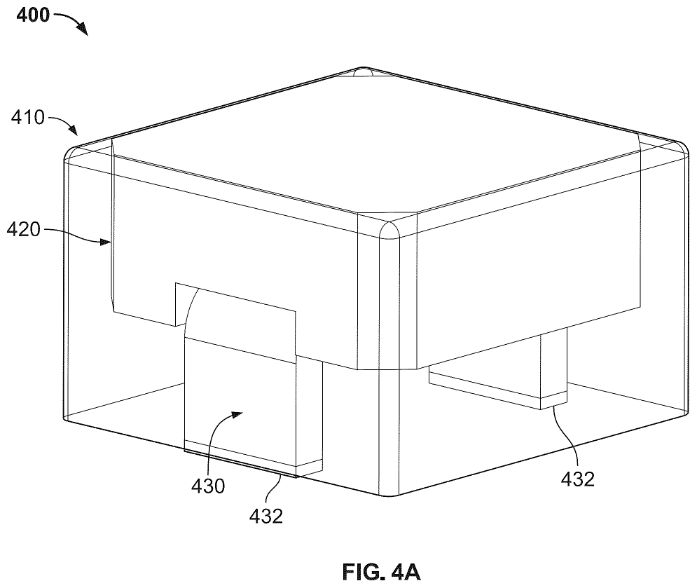

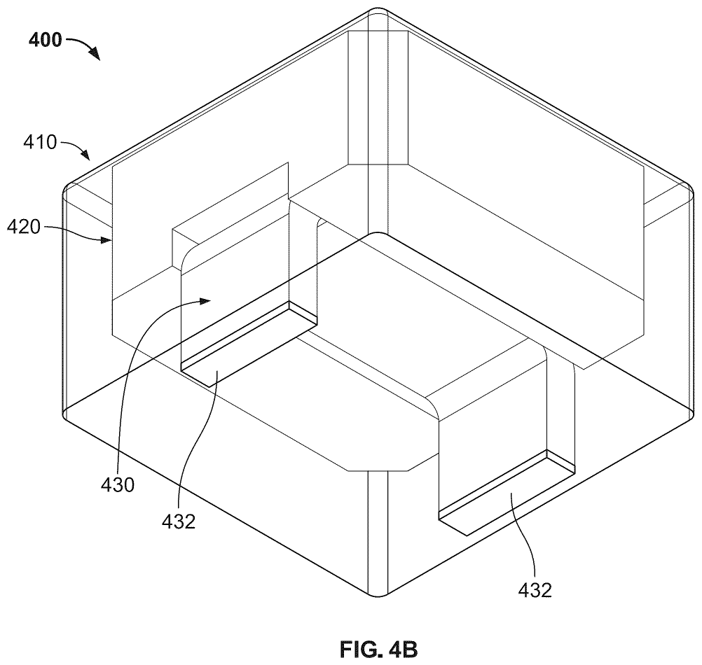

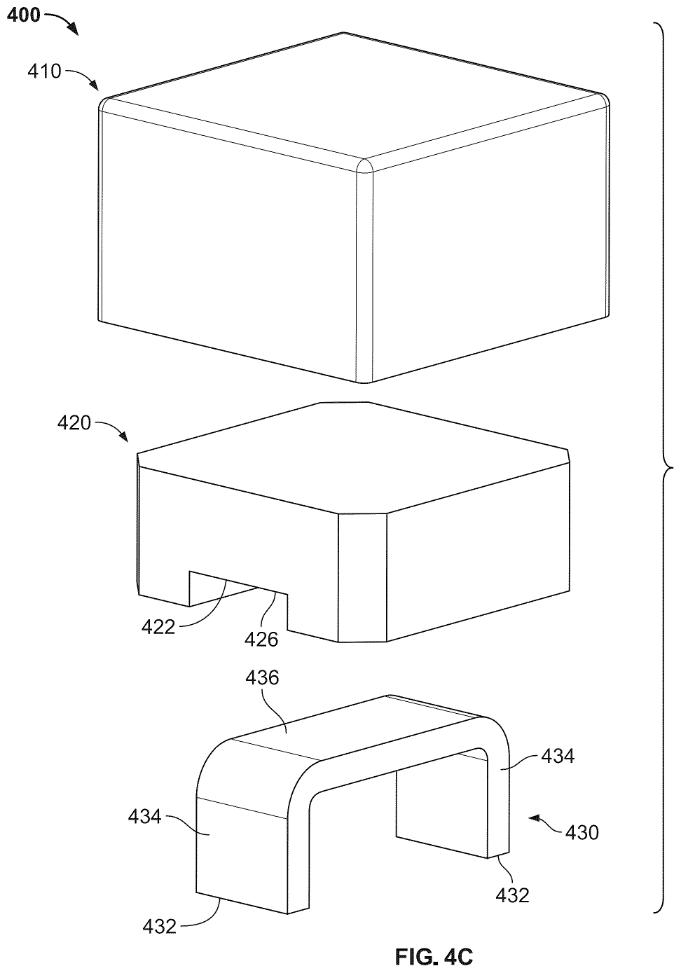

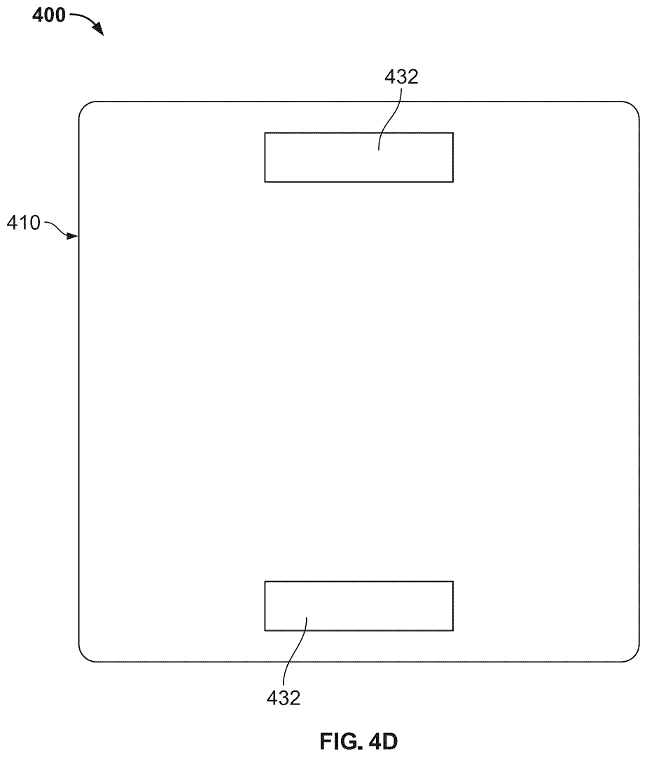

FIGS. 4A, 4B, 4C, and 4D illustrate a top perspective view, a bottom perspective view, an exploded view, and a top plan view (respectively) of inductor 400, according to embodiments. The inductor 400 may have an inductance between 10 nH-1.0 μH (e.g. approximately 100 nH). The inductance of the inductor 400 may have a tolerance of +/−5% to +/−30% (e.g., approximately 20%). The inductor 400 may have a DC resistance (DCR) between 0.05-100 m$2 (e.g., approximately 0.10 m (2).

The inductor 400 includes overmold 410, winding 430, and core 420. The inductor 400 may be similar to the inductor 100, with one exception being that the winding 430 is inverted, as will be further discussed. The inductor 400 is shown upside down, and as depicted, the upper surface of the inductor 400 would face the mounting substrate (e.g., printed circuit board).

The core 420 may be formed from different materials, such as ferrite or composite. Examples of such materials include: carbonyl iron alloys, silicon iron chromium alloys, silicon iron aluminum alloys, nanocrystalline and amorphous materials, or other soft magnetic materials. Different shapes are possible. Cores may be formed by pressing the material to a shape and then grinding the shape to a final, desired shape. The core 420 may have a length of between 2-30 mm. The core 420 may have a width of between 2-30 mm. The core 420 may have a height of between 1-20 mm.

The core 420 is shown as having a recess 421 or receiving feature to receive the winding 430. The recess 421 may have a width between 0.5-20 mm along its length. The width of the recess 421 may be greater than the corresponding width of the winding 430, as shown. The recess 421 may receive all or a portion of the winding 430. For example, the depth of the recess 421 may be at least as deep or deeper than the thickness of the winding 430. The depth of the recess 421 may be between 0.1-15 mm. As shown, the recess 421 is deeper than the winding 430. The core 420 has a lower surface 426. The lower surface 426 may be substantially planar.

The winding 430 may have a vertically oriented staple shape or “U”-shape, although other shapes are possible. The winding 430 is shown as having a horizontal segment 436 and two vertical segments 434 on opposing sides of the horizontal segment 436. The winding 430 is received by the recess 421 in the core 420. The size of the winding 430 may impact the inductance and resistivity (DCR) of the inductor 400. The greater the cross-section of the winding 430, the lower the inductance and DCR may be. Winding may include a material, such as copper, silver, or aluminum

At the ends of the winding 430, there are terminals 432. The terminals 432 may be on the actual ends of the winding 430. The terminals 432 may be substantially planar, and may be formed by, e.g., mold tooling. The terminals 432 may be so-called butt joint terminals. Butt joint terminals can be distinguished from terminals with a clip termination, or terminals with a self-lead under inductor termination terminals. As butt joint terminals, the terminals 432 may be mechanically realized in construction of electronics, because the overmold 410 secures the winding 430 with core 420. Further, as butt joint terminals, the terminals 432 reduce the height of inductor by eliminating bent wire(s) under the inductor 400. Further, as butt joint terminals, the terminals 432 may be “self-leaded” such that no interconnects between the winding 430 and a corresponding terminal 432 are required inside of the inductor 100. Because no such interconnection is needed, there is no risk of failure of such interconnection (e.g., becoming open). Further, circuit manufacturing may be improved because soldering to a butt joint terminal 432 allows for a lower profile part.

The terminals 432 may be substantially flush with an upper surface (as depicted) of the overmold 410, or the terminals 432 may extend above the upper surface of the overmold 410. For example, the terminals 432 may extend between 0.1-1.0 mm above the upper surface of the overmold 410.

The overmold 410 may be a material with either composite or ferrite magnetic material or a mix thereof. The overmold 410 may be a mix of magnetic powder (ferrite or magnetic composite powder) with a binder. The powder granules for the magnetic powder may have an average or specific diameter between 1-100 μm or up to 900 μm. The powder granules for the binder may have an average or specific diameter between 1-100 or up to 900 μm. The binder may melt during the molding process and later be processed, resulting in a substantially solid overmold. The ratio of magnetic material to binder may be between 85%: 15% to 98%: 2% by weight. The binder may be thermoplastic, thermoset, epoxy or other material that suitably melts and then can be cured or baked to form a molded body. The binder may be a mix of suitable materials. The overmold 410 may be formed by injection, compression, transfer molded, or a combination thereof.

Formation of the overmold 410 may be different than formation of the core 420. For example, the core 420 may be formed by firing at relatively high temperature (e.g., over 800° C.). Such high temperature may increase magnetic properties of the core 420. In contrast, overmold material may be baked at relatively lower temperatures (e.g., 300°−500° F.) to form the overmold 410.

The inductor 400 may be constructed as follows. The winding 430 may be placed on the core 420. The winding 430 may further fit into the part of the mold tooling (e.g., received in recesses of the tool) before forming the overmold in the tool. In this way, the terminals 432 of the winding 430 may not be covered by the overmold 410 and may extend above the upper surface of the overmold 410.

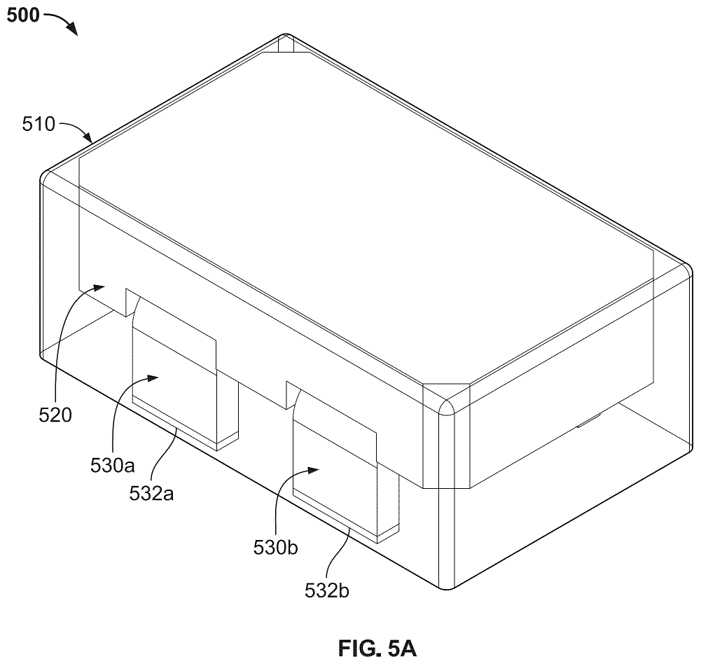

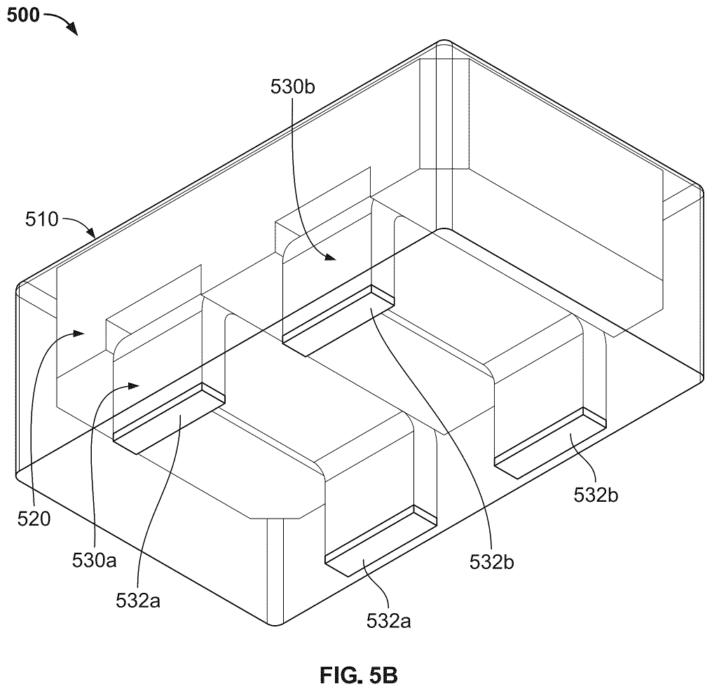

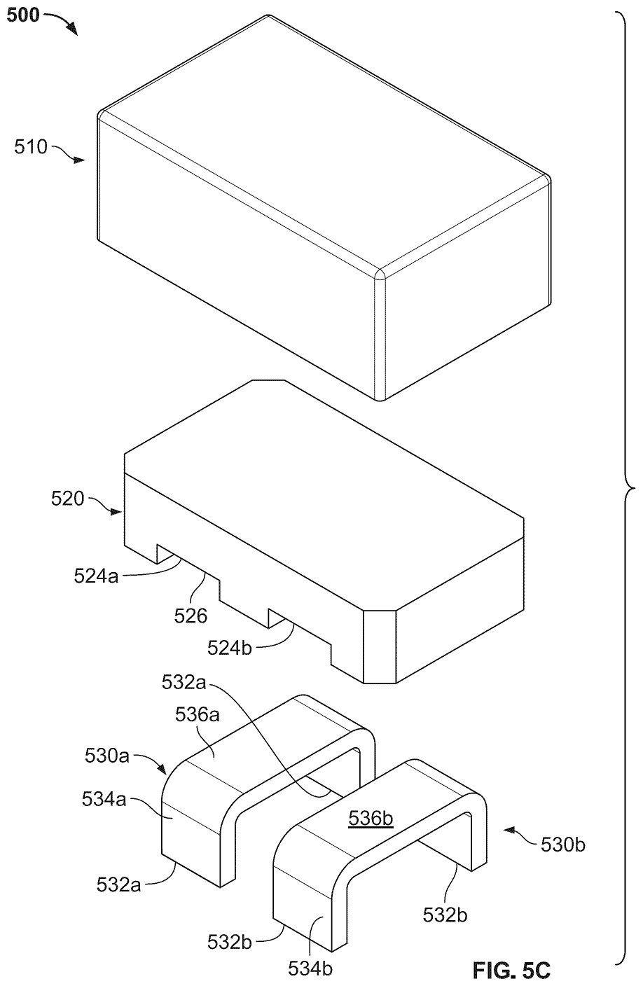

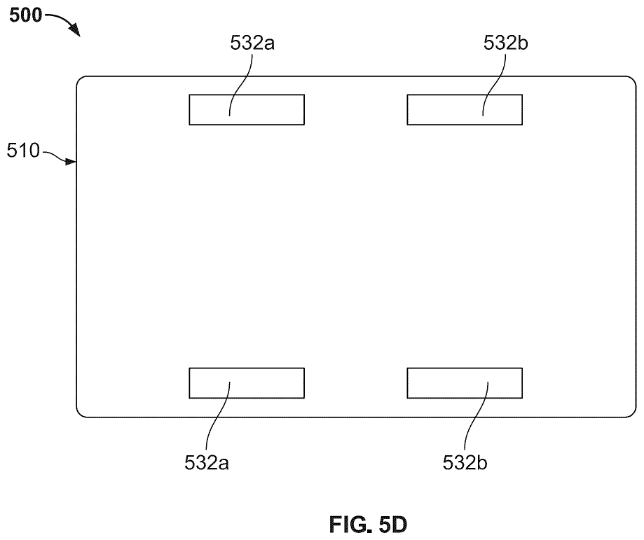

FIGS. 5A, 5B, 5C, and 5D illustrate a top perspective view, a bottom perspective view, an exploded view, and a top plan view (respectively) of an inductor 500, according to embodiments. The inductor 500 may be similar to the inductor 400, except that the inductor 500 includes multiple windings 530a, 530b and corresponding features in the core 520. Therefore, the specific descriptions will not be repeated here. The inductor 500 is shown as having two windings 530a, 530b, but three or more windings (and corresponding features on the core 520) are also contemplated. The windings 530a, 530b may be identical to each other. The corresponding features on the core 520 that receive the windings 530a, 530b may also be identical to each other. As exemplarily depicted, the first winding 530a includes two terminals 532a at the ends of respective vertical segments 534a. The vertical segments 534a are connected to each other by a horizontal segment 536a. The core 520 receives the first winding 530a, with a recess 521. As exemplarily depicted, the second winding 530b includes two terminals 532b at the ends of respective vertical segments 534b. The vertical segments 534b are connected to each other by a horizontal segment 536b. The core 520 receives the first winding 530b, with a recess 521b. The inductor 500 may be constructed in a similar manner as the inductor 400.

PARTS LIST

| Number | Part |
|---|---|
| 100 | Transformer |
| 110 | Overmold |
| 120 | Core |
| 121 | Core recess |
| 122 | Core lateral recess segment |
| 124 | Core upper recess segment |
| 126 | Core lower surface |
| 130 | Winding |
| 132 | Winding terminal |
| 134 | Winding lateral segment |
| 136 | Winding upper segment |
| 200 | Transformer |
| 210 | Overmold |
| 220 | Core |
| 222 | Core recess |
| 226 | Core lower surface |
| 230 | Winding |
| 232 | Winding terminal |
| 234 | Winding upper widthwise segment |
| 236 | Winding upper lengthwise segment |
| 238 | Winding lateral segment |
| 240 | Dummy winding |
| 242 | Dummy winding terminal |
| 244 | Dummy winding horizontal segment |
| 246 | Dummy winding vertical segment |
| 300 | Transformer |
| 310 | Overmold |
| 320 | Core |
| 321a | Core recess |
| 321b | Core recess |
| 322a | Core first lateral recess segment |
| 322b | Core second lateral recess segment |
| 324a | Core first upper recess segment |
| 324b | Core second upper recess segment |
| 326 | Core lower surface |
| 330a | First winding |
| 330b | Second winding |
| 332a | First winding terminal |
| 332b | Second winding terminal |
| 334a | First winding lateral segment |
| 334b | Second winding lateral segment |
| 336a | First winding upper segment |
| 336b | Second winding upper segment |
| 400 | Transformer |
| 410 | Overmold |
| 420 | Core |
| 421 | Core recess |
| 426 | Core lower surface |
| 430 | Winding |
| 432 | Winding terminal |
| 434 | Winding vertical segment |
| 436 | Winding horizontal segment |
| 500 | Transformer |
| 510 | Overmold |
| 520 | Core |
| 521a | Core recess |
| 521b | Core recess |
| 526 | Core lower surface |
| 530a | First winding |
| 530b | Second winding |
| 532a | First winding terminal |
| 532b | Second winding terminal |
| 534a | First winding vertical segment |
| 534b | Second winding vertical segment |
| 536a | First winding horizontal segment |
| 536b | Second winding horizontal segment |

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An inductor comprising:
a core;
at least one winding received by a corresponding recess in the core, wherein each of the at least one winding includes a vertically-oriented “U” shape; and
an overmold covering an upper region of the core and at least a portion of each of the at least one winding.

2. The inductor of claim 1, wherein each of the at least one winding comprises two terminals on an underside of the inductor, wherein the terminals are butt joint terminals.

3. The inductor of claim 1, wherein the at least one winding includes a plurality of windings.

4. The inductor of any one of claim 1, wherein the overmold does not cover portions of the at least one winding, including terminals of each of the at least one winding.

5. The inductor of claim 4, wherein uncovered portions of the at least one winding each extend at least 0.1 mm below a lower surface of the core.

6. An inductor comprising:
a core;
at least one winding at least partially arranged around core, wherein each of the at least one winding has a horizontally-oriented “U” shape portion and two vertically-oriented portions extending downwardly from corresponding ends of the horizontally-oriented “U” shape to a bottom surface of the inductor; and
an overmold covering the core and at least a portion of each of the at least one winding.

7. The inductor of claim 6, wherein each of the at least one winding comprises two terminals on a bottom surface of the inductor on respective ones of the two vertically-oriented portions of the winding, wherein the terminals are butt joint terminals.

8. The inductor of claim 6, wherein the inductor further comprises a dummy winding not electrically connected to the at least one winding, wherein the dummy winding includes at least one dummy winding terminal on a bottom surface of the inductor, wherein the overmold covers at least a portion of the dummy winding and wherein the at least one dummy winding terminal comprises a butt joint terminal.

9. The inductor of claim 8, wherein at least a portion of the dummy winding including the at least one dummy winding terminal extends at least 0.1 mm below a lower surface of the core.

10. The inductor of claim 6, wherein the at least one winding includes a plurality of windings.

11. The inductor of claim 7, wherein the overmold does not cover a portion of the at least one winding, including the two terminals of each of the at least one winding.

12. The inductor of claim 11, wherein uncovered portions of the at least one winding each extend at least 0.1 mm below a lower surface of the core.

13. A method for manufacturing an inductor comprising:
placing at least one winding on a core; and
forming an overmold around the core and at least a portion of the winding by baking a composite material.

14. The method of claim 13, wherein the method further comprises positioning a dummy winding before said forming an overmold, wherein the dummy winding includes at least one dummy winding terminal, and wherein the overmold is formed around at least a portion of the dummy winding.

15. The method of claim 14, wherein the at least one dummy winding terminal includes a butt-joint terminal.

16. The method of claim 15, wherein the at least one dummy winding terminal extends at least 0.1 mm below a lower surface of the core.

17. The method of claim 13, wherein the overmold is formed by baking at a temperature between 300-500 degrees F.

18. The method of claim 13, wherein the overmold comprises a binder and a magnetic material, wherein the binder comprises at least one of a thermoplastic, a thermoset, or an epoxy material, and wherein a ratio of the magnetic material to binder by percentage of weight is between 85:15 and 97:3.

19. The method of claim 13, wherein the winding includes two butt-joint terminals on a bottom surface of the inductor after the overmold has been formed.

20. The method of claim 19, wherein uncovered portions of the at least one winding each extend at least 0.1 mm below a lower surface of the core.
